(19) United States
(12) Patent Application Publication
(10) Pub. No.: US 2015/0103533 A1
(43) Pub. Date: Apr. 16, 2015

(54) LENS AND LIGHT SOURCE MODULE WITH THE SAME

(71) Applicant: HON HAI PRECISION INDUSTRY CO., LTD., New Taipei (TW)

(72) Inventors: LI-YING WANG HE, Tu-Cheng (TW); YI HUNG, Tu-Cheng (TW)

(73) Assignee: HON HAI PRECISION INDUSTRY CO., LTD., New Taipei (TW)

(21) Appl. No.: 14/086,979

(22) Filed: Nov. 22, 2013

(30) Foreign Application Priority Data
Oct. 11, 2013 (TW) 102136694

(51) Int. Cl. F21V 5/04; F21K 99/00

(52) U.S. Cl. CPC F21V 5/04; F21K 9/50
USPC 362/311.02; 362/335; 362/311.01

(57) ABSTRACT

The present disclosure relates to a lens. The lens includes a bottom surface, a light input surface and a light output surface. The light input surface is a curved surface depressing from a center of the bottom surface. The light output surface is opposite to the bottom surface. The light output surface includes a planar surface located at a center thereof and a convex surface located at peripheral thereof and surrounding the planar surface. The planar surface includes a plurality of micro structures located at a central area thereof. The present disclosure also relates to a light source module with the lens.

### BACKGROUND

1. Technical Field

The disclosure relates to a lens and a light source module with the lens.

2. Discussion of Related Art

Light emitting diodes' (LEDs) many advantages, such as high luminosity, low operational voltage, low power consumption, compatibility with integrated circuits, easy driving, long term reliability, and environmental friendliness have promoted their wide use as a lighting source.

However, the conventional LED illumination apparatus generally has a radiation angle about 120 degrees and generates a butterfly-type light field. The intensity of light emitted by the LED illumination apparatus dramatically decreases when the radiation angle exceeds 120 degrees.

Therefore, what is needed is a lens and a light source module with the lens which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present the lens and the light source module for microminiaturization. Moreover, in the drawing, like reference numerals designate corresponding parts throughout the whole view.

FIG. 1 is a cross-sectional view of a light source module according to an exemplary embodiment of the present disclosure.

FIG. 2 is a schematic, isometric view of a lens of the light source module of FIG. 1.

FIG. 3 is an inverted view of the lens of FIG. 2.

FIG. 4 is a cross-sectional view of the lens of FIG. 2, taken along line IV-IV thereof.

FIG. 5 is an enlarged view of a part V of the lens of FIG. 2.

### DETAILED DESCRIPTION OF EMBODIMENTS

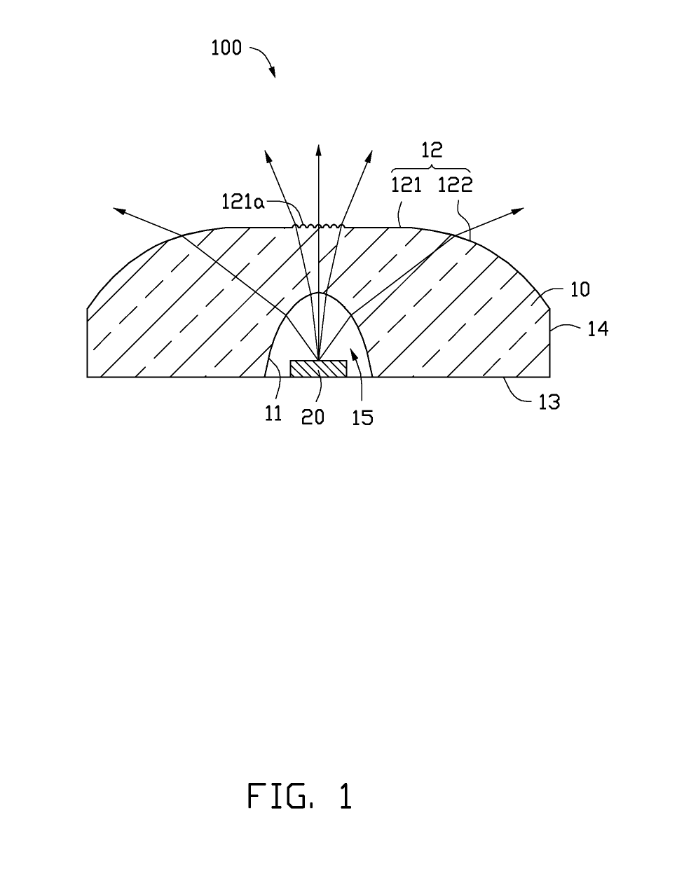

Referring to FIG. 1, a light source module 100 in accordance with an exemplary embodiment of the present disclosure is illustrated. The light source module 100 includes a lens 10 and a light source 20. Light emitted from the light source 20 is adjusted by the lens 10.

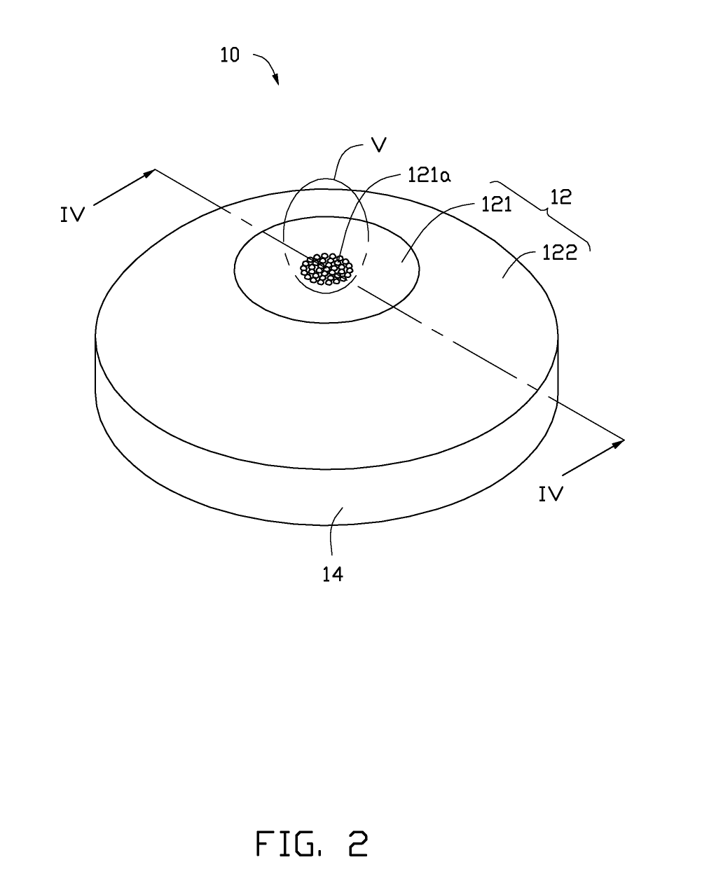

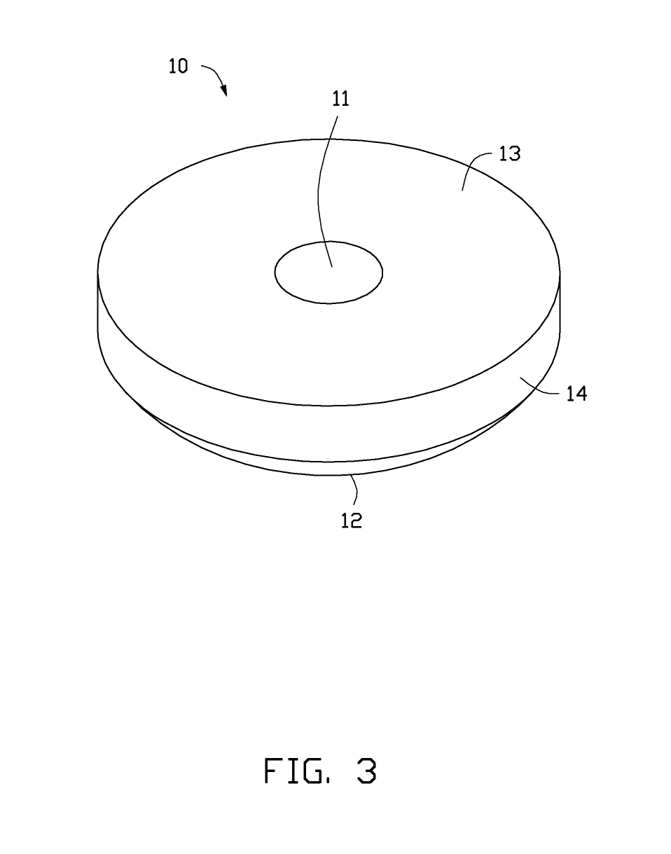

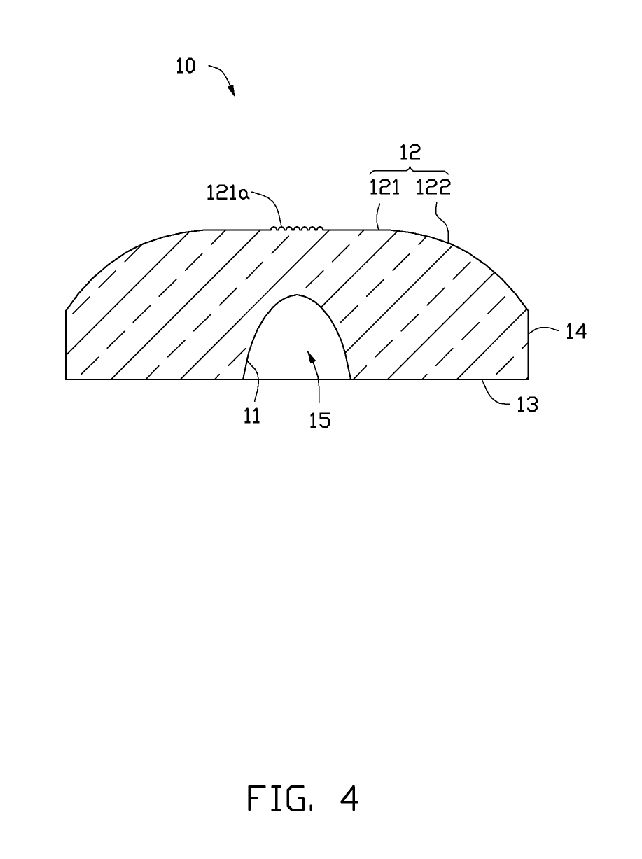

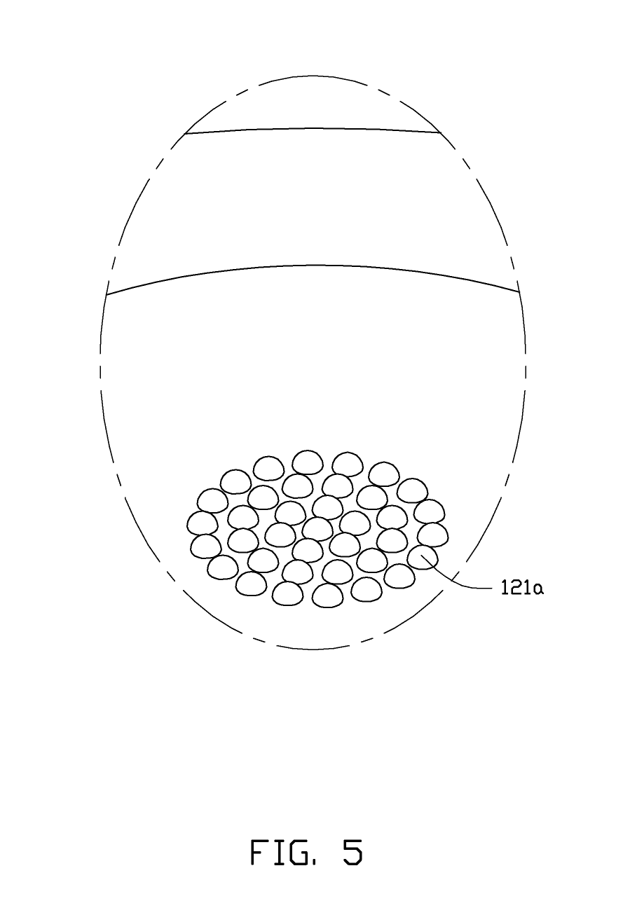

Referring to FIGS. 2 to 5, the lens 10 is substantially cylindrical, and includes a bottom surface 13, a light input surface 11, a light output surface 12 and a side surface 14.

The bottom surface 13 is a planar circular surface. The light input surface 11 is a curved surface depressing from a center of the bottom surface 13 towards the light output surface 12 of the lens 10. The light input surface 11 defines a cavity 15. In the present embodiment, a central axis of the light input surface 11 is coaxial to that of the lens 10. The light input surface 11 is substantially elliptical, and a short axis of the elliptical light input surface 11 is substantially coplanar with the bottom surface 13, and a long axis of the elliptical light input surface 11 is perpendicular to the bottom surface 13.

The light output surface 12 is opposite to the bottom surface 13. The light output surface 12 is an aspheric surface and includes a planar surface 121 located at a center thereof and a convex surface 122 located at peripheral thereof and surrounding the planar surface 121. The planar surface 121 is just opposite to the light input surface 11. The convex surface 122 smoothly connects the planar surface 121 and is used for diverging side light (i.e., light having a large emerging angle) emitted from the light source 20.

The planar surface 121 includes a plurality of micro structures 121a at a central area thereof. The micro structures 121a of the planar surface 121 are just opposite to the light input surface 11. In the present embodiment, the micro structures 121 a are semi sphere shaped protrusions. The micro structures 121 a are configured for diverging light emitted from the light source 20. In the present embodiment, a diameter of each micro structure 121a is 0.05 mm. One of the micro structures 121a is arranged on a center of the planar surface 121, and the other micro structures 121a are evenly spaced outwardly and radially from the central micro structure 121a. The micro structures 121a are used for diverging direct light (i.e., light having a small emerging angle) emitted from the light source 20.

The side surface 14 connects the bottom surface 13 and the light output surface 12. In the present embodiment, the side surface 14 is perpendicular to the bottom surface 13. The first side surface 14 is substantially cylindrical.

The light source 20 faces the light input surface 11 of the lens 10 and is received in the cavity 15 defined by the light input surface 11. In the present embodiment, a bottom surface of the light source 21 is coplanar with the bottom surface 13 of the first lens 10. The light source 20 is an LED, and a central axis of the LED is coaxial to that of the lens 10.

Part of the light beams emitted from a center of the light source 20 enter the lens 10 via the light input surface 11 and scattered by the micro structures 121 a to different directions deviating from the central axis of the light source 20. The other parts of light beams emitted from the light source 20 enter the lens 10 and scattered by the light output surface 12 to outside. Accordingly, the light intensity at the center of the light field is decreased, and a periphery of the light filed in increased. Thus, the light source module 100 can achieve a uniform distribution for the light intensity of the light filed.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

1. A lens comprising:
a bottom surface;
a light input surface being a curved surface depressing from a center of the bottom surface;
a light output surface opposite to the bottom surface, the light output surface comprising a planar surface located at a center thereof and a convex surface located at peripheral thereof and surrounding the planar surface, the planar surface comprising a plurality of micro structures located at a central area thereof; and
a cylindrical side surface connected to the bottom surface and the light output surface, the side surface being perpendicular to the bottom surface;
wherein the lens is cylindrical and has a cylindrical axis, the light input surface is an ellipsoid of revolution having a long axis coaxial with cylindrical axis of the lens, and an apex of the light input surface is located at a position slightly higher than an upper edge of the cylindrical side surface with respect to the bottom surface; and
wherein an area of the convex surface located at the peripheral of the planar surface of the light output surface is relatively larger than that of the planar surface of the light output surface.

2.-8. (canceled)

9. A light source module comprising a lens and a light source facing the lens, the lens comprising:
a bottom surface;
a light input surface being a curved surface depressing from a center of the bottom surface, the light source facing the light input surface;
a light output surface opposite to the bottom surface, the light output surface comprising a planar surface located at a center thereof and a convex surface located at peripheral thereof and surrounding the planar surface, the planar surface comprising a plurality of micro structures located at a central area thereof; and
a cylindrical side surface connected to the bottom surface and the light output surface, the side surface being perpendicular to the bottom surface;
wherein the lens is cylindrical and has a cylindrical axis, the light input surface is an ellipsoid of revolution having a long axis coaxial with cylindrical axis of the lens, and an apex of the light input surface is located at a position slightly higher than an upper edge of the cylindrical side surface with respect to the bottom surface; and
wherein an area of the convex surface located at the peripheral of the planar surface of the light output surface is relatively larger than that of the planar surface of the light output surface.

10.-15. (canceled)
